(19) United States
(12) Patent Application Publication
(10) Pub. No.: US 2026/0332530 A1
(43) Pub. Date: Oct. 22, 2026

(54) HARDWARE ACCELERATION OF ROUTING PROTOCOLS IN DATA CENTER FABRICS

(71) Applicant: Cisco Technology, Inc., San Jose, CA (US)

(72) Inventors: Clarence Andre M. Filsfils, Uccle (BE); Pablo Camarillo Garvia, Madrid (ES); Ahmed Mohamed Ahmed Abdelsalam, L’Aquila (IT); Carmine Scarpitta, Santa Marina (IT)

(73) Assignee: Cisco Technology, Inc., San Jose, CA (US)

(21) Appl. No.: 19/563,695

(22) Filed: Mar. 11, 2026

Related U.S. Application Data
(60) Provisional application No. 63/777,248, filed on Mar. 25, 2025.

(51) Int. Cl. H04L 47/125; H04L 41/14; H04L 45/24; H04L 47/122

(52) U.S. Cl. CPC H04L 47/125; H04L 41/145; H04L 45/24; H04L 47/122

(57) ABSTRACT

In one implementation, a device in a network represents one or more connections between the device and one or more other devices in the network as a local vector having gradients that represent capacities of those one or more connections. The device receives a second vector from a remote device from among the one or more other devices that represents any available connections for the remote device and their capacities. The device updates a hardware-accelerated load balancing mechanism of the device using the local vector and the second vector. The device uses the hardware-accelerated load balancing mechanism of the device to send a load-balanced portion of its traffic to the remote device based on the local vector and the second vector.

### RELATED APPLICATIONS

The present disclosure claims priority to U.S. Prov. Appl. Ser. No. 63/777,248, filed on Mar. 25, 2025, entitled “HARDWARE ACCELERATION OF ROUTING PROTOCOLS IN DATA CENTER FABRICS,” by Filsfils, et al., the contents of which are incorporated herein by reference.

### TECHNICAL FIELD

The present disclosure relates generally to network compute fabrics and, more particularly to hardware acceleration of routing protocols in data center fabrics.

### BACKGROUND

In modern artificial intelligence (AI) and high-performance computing (HPC), fabric resources are not unlimited. This means that different AI model training and other computing tasks often need to be scheduled, resulting in some of the tasks having to wait for execution. Indeed, recent studies estimate that approximately 33% of the processing time for all AI tasks is attributable to waiting on backend network delays.

Common network implementations for connecting front-end CPU-based networks and backend GPU-based HPC networks to facilitate data transfer and high-performance computing tasks include High-Speed Ethernet, InfiniBand, NVLink, Peripheral Component Interconnect Express (PCIe), and Fibre Channel (FC), among others. When it comes to AI workloads, a front-end network scheduler is typically used to schedule and orchestrate AI-related workloads ranging from model training to inferencing and data processing. This scheduling often entails coordinating various resources and services, managing job queues, and ensuring that the right data and computational resources are available.

Today, however, routing protocols in data center fabrics lack any hardware acceleration.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with an artificial intelligence (AI) model;

FIG. 4 illustrates an example architecture for an AI agent;

FIG. 5 illustrates an example network or compute fabric for performing AI model training and high-performance computing (HPC) tasks;

FIGS. 6A-6B illustrate an example of the computation of a local vector of gradients;

FIGS. 7A-7F illustrate a first example of applying the techniques herein to a data center fabric;

FIG. 8 illustrates a second example of applying the techniques herein to a data center fabric;

FIG. 9 illustrates a third example of applying the techniques herein to a data center fabric; and

FIG. 10 illustrates an example simplified procedure for the hardware acceleration of routing protocols in data center fabrics, in accordance with one or more implementations described herein.

### DESCRIPTION OF EXAMPLE IMPLEMENTATIONS

### Overview

According to one or more implementations of the disclosure, a device in a network represents one or more connections between the device and one or more other devices in the network as a local vector having gradients that represent capacities of those one or more connections. The device receives a second vector from a remote device from among the one or more other devices that represents any available connections for the remote device and their capacities. The device updates a hardware-accelerated load balancing mechanism of the device using the local vector and the second vector. The device uses the hardware-accelerated load balancing mechanism of the device to send a load-balanced portion of its traffic to the remote device based on the local vector and the second vector.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

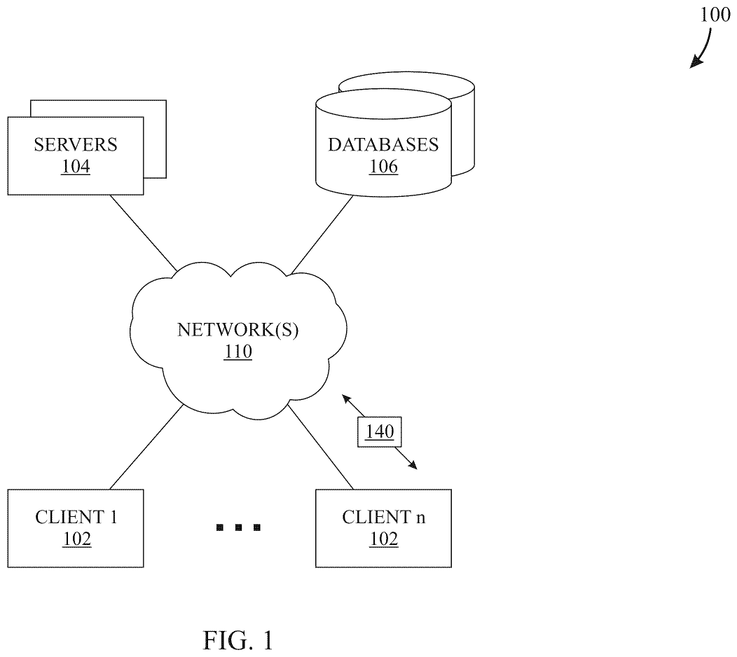

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

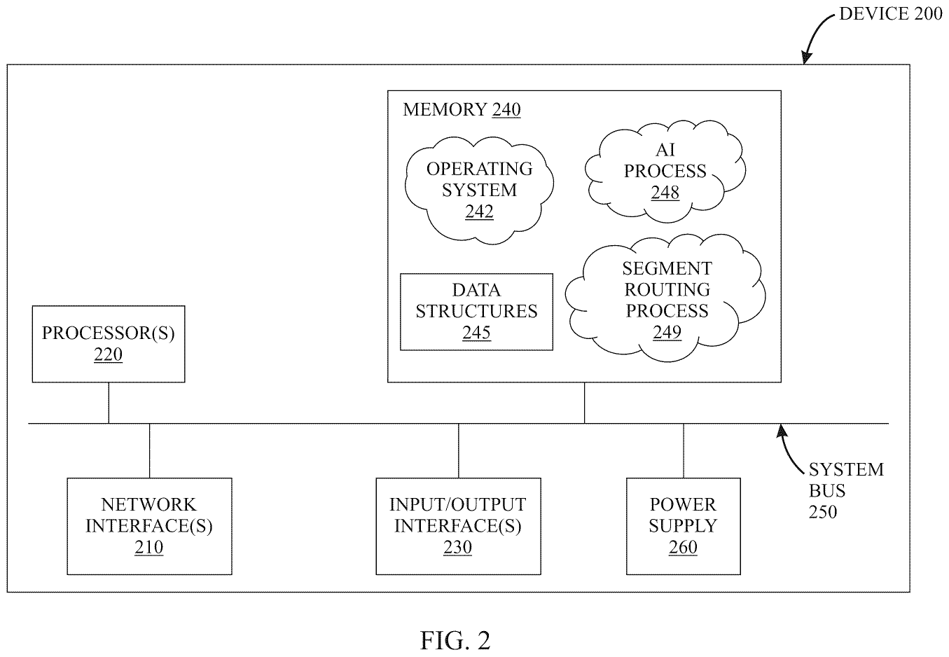

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248 and/or a segment routing process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

Segment routing process 249 includes computer executable instructions executed by processor 220 to perform functions in accordance with one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP) (e.g., in conjunction with AI process 248), etc., as will be understood by those skilled in the art. For instance, these operations may include configuring and managing a forwarding information database containing, e.g., data used to make forwarding decisions. In particular, changes in the network topology may be communicated among devices in the computer network, such as device 200, using a routing protocol, such as the OSPF or IS-IS link-state protocols, to “converge” to an identical view of the network topology.

In various implementations, segment routing process 249 may cause device 200 to perform segment routing in the network, such as, e.g., in conjunction with Multiprotocol Label Switching (MPLS). For example, segment routing process 249 may utilize extensions to the IGP (e.g., IS-IS, OSPF, etc.), that allow IGP messages to carry MPLS label information, to use segment routing within the network.

In general, segments in a segment routed network may fall into one of two categories: node segments and adjacency segments. Adjacency segments generally represent the local interface between a given node and an adjacent neighbor. Notably, adjacency segments do not need to be unique among the different nodes, as adjacency segments only require local significance to the particular node. Node segments, in contrast, are global in nature and use unique identifiers to represent node segment endpoints. When used in conjunction with MPLS, segments (e.g., node and adjacency segments) may be treated as labels, whereby a node may either “push” a new segment/label onto the stack, “pop” (e.g., remove) the top segment/label from the stack, or “swap” the top label of the stack with another label.

In various implementations, as detailed further below, AI process 248 and/or segment routing process 249 may include computer executable instructions that, when executed by processor 220, cause device 200 to perform the techniques described herein. To do so, in some implementations, AI process 248 and/or segment routing process 249 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 and/or segment routing process 249 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that AI process 248 and/or segment routing process 249 could use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 and/or segment routing process 249 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

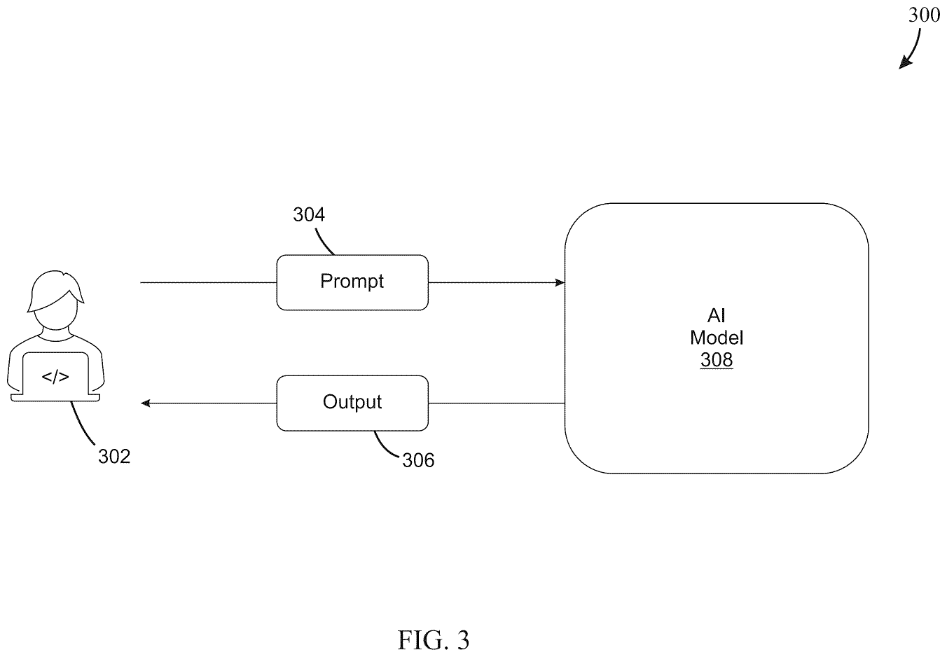

FIG. 3 illustrates an example 300 for interfacing with an AI model, in various implementations. In example 300, a user 302 may send a prompt 304 (e.g., a query, a query augmented with additional data, documents, and/or images, etc.) to an AI model 308. The AI model 308 may be configured to process a prompt 304 to generate an output 306 to satisfy the prompt 304.

AI model 308 may be a model configured to apply its trained algorithms to generate a response (e.g., output 306) based on the prompt 304 provided. More specifically, AI model 308 may be trained on a training dataset 310 and, once trained, be deployed for inference. For instance, in some cases, AI model 308 may take the form of a large language model (LLM) or other foundation model, diffusion-based model, combinations thereof, or the like.

The output 306 may be the result produced by AI model 308 (e.g., by the application of AI model 308 to the prompt 304). This output can vary depending on the model's configuration and the task at hand. For example, the output 306 may include one or more of a generated and/or synthesized image, a text response, a classification and/or prediction, etc.

As would be appreciated, AI agents are also capable of interacting with generative models, such as AI model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

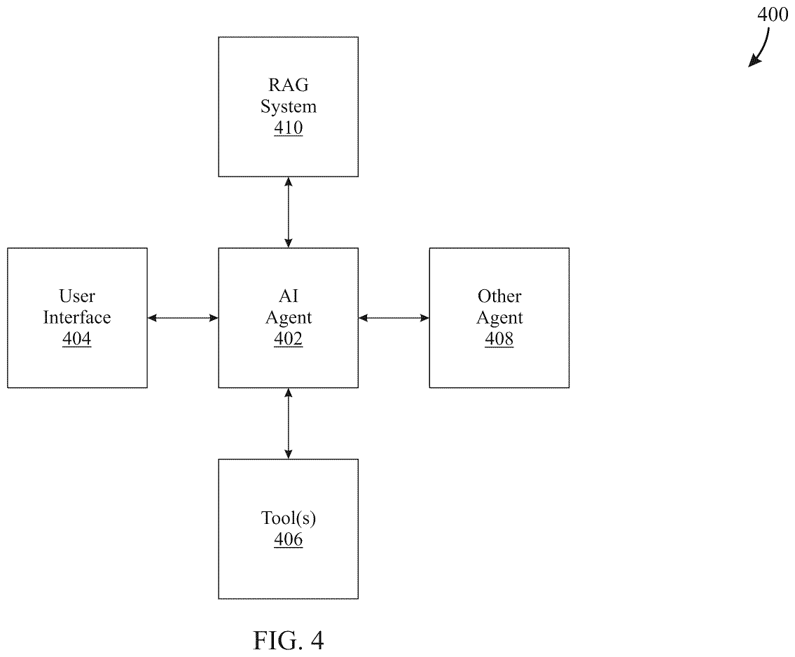

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device executing AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

Indeed, LLMs and other modern AI models are capable of performing a wide variety of tasks. In addition, agentic systems may leverage such models to perform an even larger set of tasks.

However, training an AI model and performing other high-performance computing (HPC) tasks is not straightforward, as network or compute fabric resources are not unlimited. This means that different AI model training and other computing tasks often need to be scheduled, resulting in some of the tasks having to wait for execution. Indeed, recent studies estimate that approximately 33% of the processing time for all AI tasks is attributable to waiting on backend network delays.

Common network implementations for connecting front-end CPU-based networks and backend GPU-based HPC networks to facilitate data transfer and high-performance computing tasks include High-Speed Ethernet, InfiniBand, NVLink, Peripheral Component Interconnect Express (PCIe), and Fibre Channel (FC), among others. When it comes to AI workloads, a front-end network scheduler is typically used to schedule and orchestrate AI-related workloads ranging from model training to inferencing and data processing. This scheduling often entails coordinating various resources and services, managing job queues, and ensuring that the right data and computational resources are available.

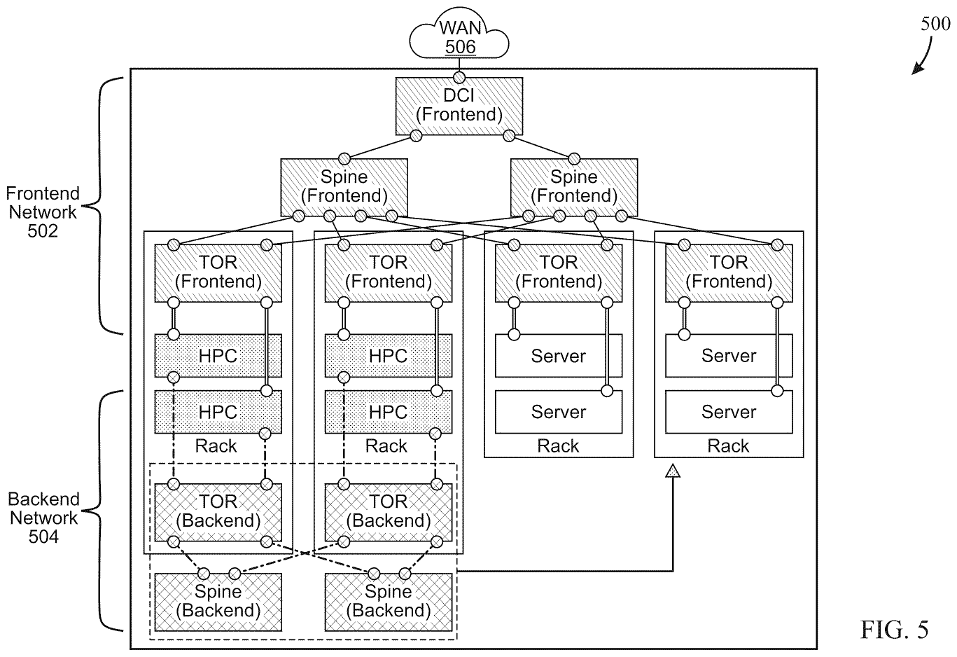

By way of example, FIG. 5 illustrates an example network or compute fabric 500 for performing AI model training and HPC tasks, according to various implementations. As shown, network or compute fabric 500 may include a frontend network 502 and a backend network 504. Network or compute fabric 500 may also be connected to a WAN 506, allowing for remote access.

For instance, frontend network 502 may include various components such as a data center interconnect (DCI), any number of frontend spines, a plurality of top-of-rack (TOR) switches, etc. Likewise, backend network 504 may include HPC clusters, servers, its own backend TOR switches, etc. on the racks, as well as its own backend spines. As would be appreciated, the specific configuration and components of frontend network 502 and backend network 504 may differ as desired. --Hardware Acceleration of Routing Protocols in Data Center Fabrics

The techniques herein allow for hardware acceleration of the routing protocol in data center fabrics.

Illustratively, the techniques described herein may be performed by hardware, software, and/or firmware, such through execution of segment routing process 249, which may include computer executable instructions executed by the processor 220 (or independent processor of interfaces 210) to perform functions relating to the techniques described herein, e.g., in conjunction with AI process 248.

Specifically, according to various implementations, a device in a network represents one or more connections between the device and one or more other devices in the network as a local vector having gradients that represent capacities of those one or more connections. The device receives a second vector from a remote device from among the one or more other devices that represents any available connections for the remote device and their capacities. The device updates a hardware-accelerated load balancing mechanism of the device using the local vector and the second vector. The device uses the hardware-accelerated load balancing mechanism of the device to send a load-balanced portion of its traffic to the remote device based on the local vector and the second vector.

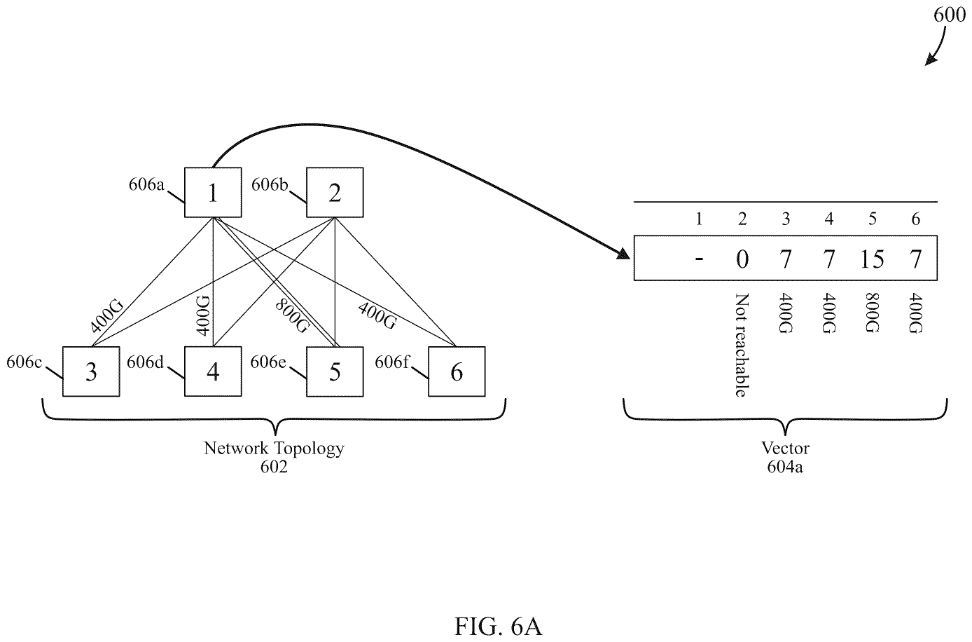

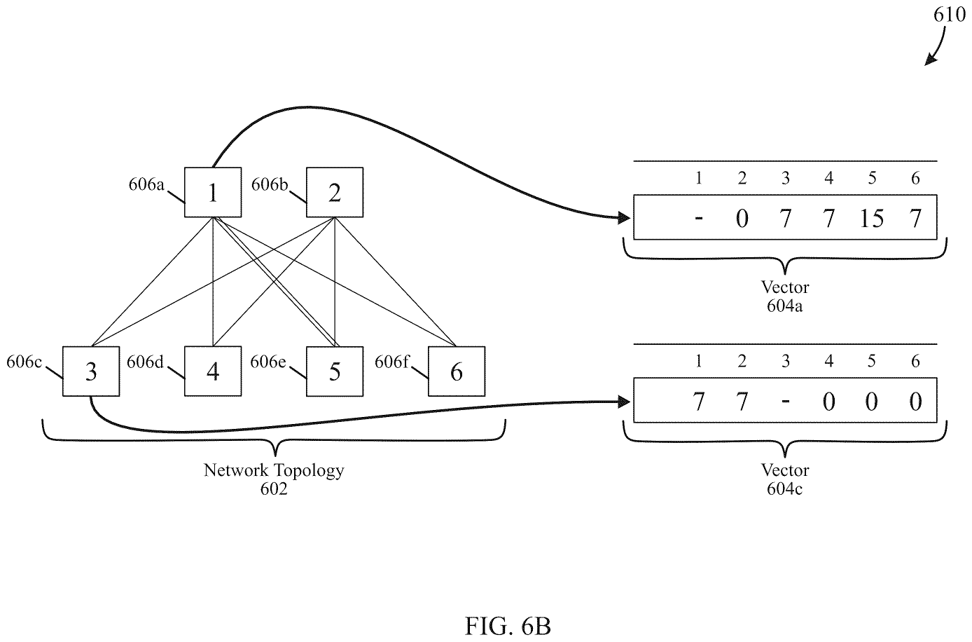

Operationally, FIGS. 6A-6B illustrates an example 600 of the computation of a local vector of gradients, according to various implementations. In FIG. 6A, a reference network topology 602 is shown comprising node 606a through node 606f (e.g., a first through sixth node). The following assumptions are made with respect to reference network topology 602:
External BGP (eBGP) hop-by-hop is used (< >BGP-Link State (BGP-LS)).
The stateful load balancer (LB) abstracts the bundle management.
For BGP it is a single IP link. The complexity of the management of congestion is dealt with by the stateful LB in hardware.
In terms of node numbering, the controller (cluster day0 config.) communicates the IDs so that routers can use that order.
The ID must provide clear mapping to the BGP Router ID, which is suggested to be of the form uN(16b).

In such a case, according to various implementations, the system computes a vector for a given node represents its reachability to any other directly connected node. In addition, a gradient is used in the vector that represents the nominal capacity to the other nodes. For instance, a vector 604a for node 606a in reference network topology 602 is shown.

More specifically, the techniques herein introduce the following building blocks:
Coherent node number: A controller or other device (cluster day0 config) provisions an ID to each node in the fabric. This ID provides a clear mapping to the BGP Router ID. Hence, a value like the SRv6 uN (16b) may be used.
Local Vector of Gradients: Each node maintains a vector with its reachability to any other directly connected node. This vector is ordered according to the node number, and the gradient value represents the nominal capacity (encoded as a 4bit value). For instance, the connectivity from node 606a to node 606c (e.g., the first node to the third node) is represented in vector 604a with a gradient value of ‘7’ (as the capacity is 400 G), whereas the connectivity from node 606a to node 606e (e.g., the first node to the fifth node) is represented with a gradient of ‘15’ (as the capacity is 800 G, which is the max in the fabric).

In FIG. 6B, with respect to the leaves, every 1 ms or other suitable period, the leaf receives a vector from its neighbors. Thus, a given leaf knows both its own local vector, as well as the remote vectors of its neighbors. For instance, node 606c may maintain its own vector, vector 604c, that represents its own connectivity to node 606a and node 606b, as well as gradients that represent the capacities of those respective connections.

Here, the vector is used to grade BGP. In other words, traffic is not sent via a path that is not part of the BGP best path. In addition, Flowlet-Based Dynamic Load Balancing (FLLB) performs weighted equal cost multipath (wECMP) load balancing on the BGP best path based on the hardware congestion status. More specifically, FLLB is a hardware-accelerated mechanism performed in an application specific integrated circuit (ASIC) that optimizes traffic distributions by using a mapping between flows and distinct physical links.

More specifically, the behavior may be as follows:
Each node advertises its vector of gradients to its neighbors. This happens recurrently every 1 ms or other suitable period, and also upon any change in the topology. Therefore, each Leaf node knows its local vector, and the remote vector from all spine routers. Note that the Leaf processes this received vector in the hardware. It keeps a matrix with the reachability to each destination via every spine, with the gradients received from each on the cell. Therefore, when the vector is received, the operation from the hardware is straightforward, it simply needs to update that column in the matrix.
Upon packet forwarding time, the regular Forwarding Information Base (FIB) lookup in the router may determine the ECMP Group. The hardware block processing the hardwired routing vector performs wECMP on the BGP Best Path. This wECMP leverages the nominal capacity received on the vector. This implies that the hardware block simply subtracts, filters, or balances the result of the BGP FIB.

With respect to gradient management, the nominal capacity is updated upon link failure to zero. In addition, the nominal capacity is updated upon identification of a congestion status (e.g., by being decreased). For example, if the link is experiencing congestion, the gradient value is decreased so that less bandwidth is shown as available.

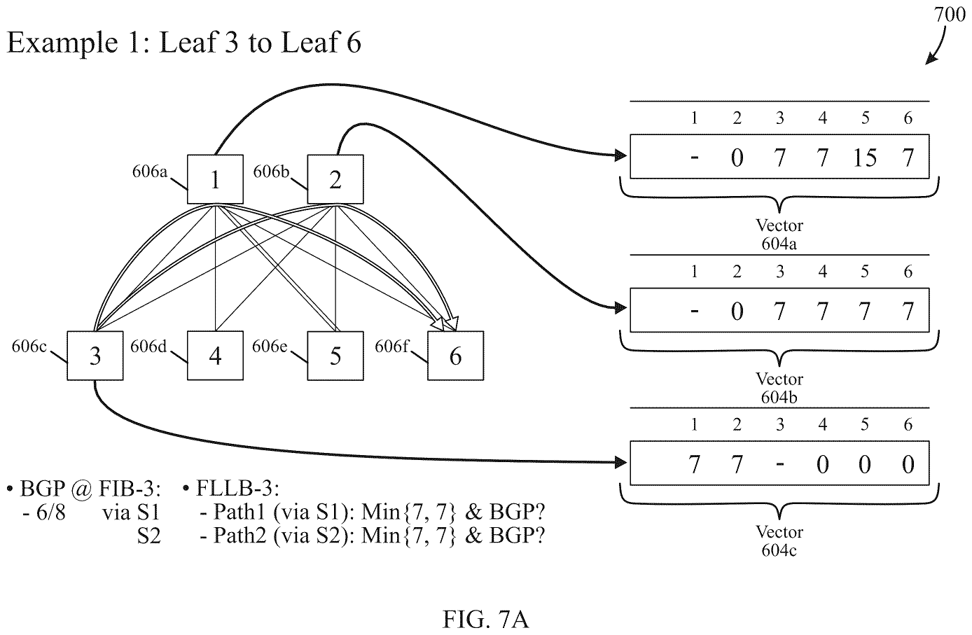

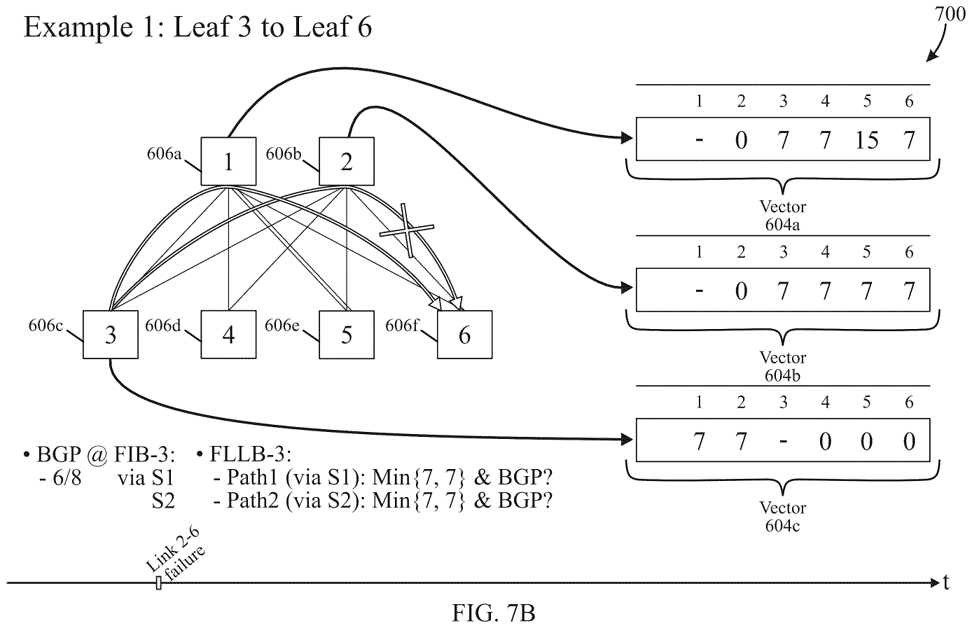

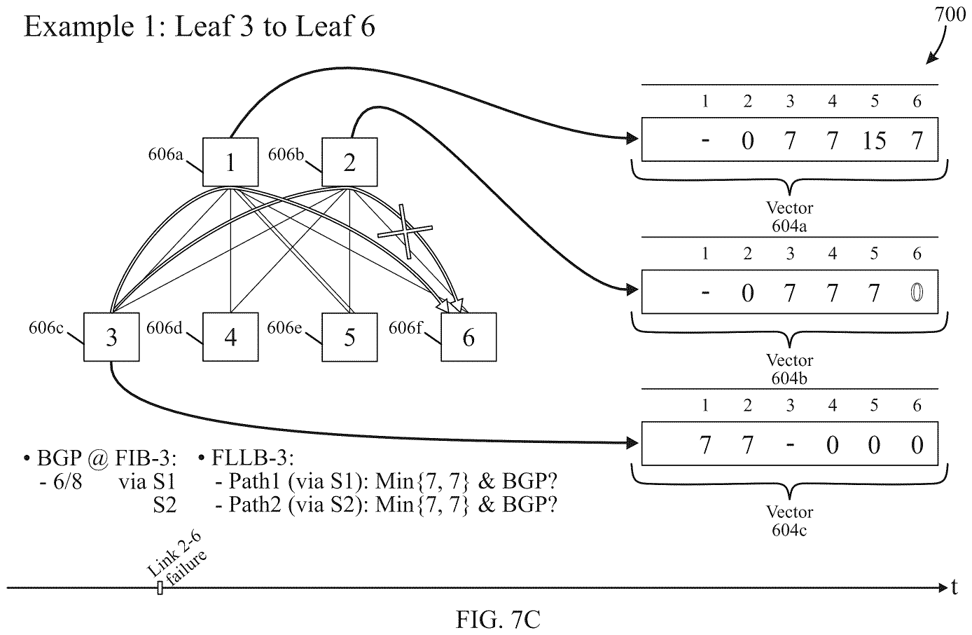

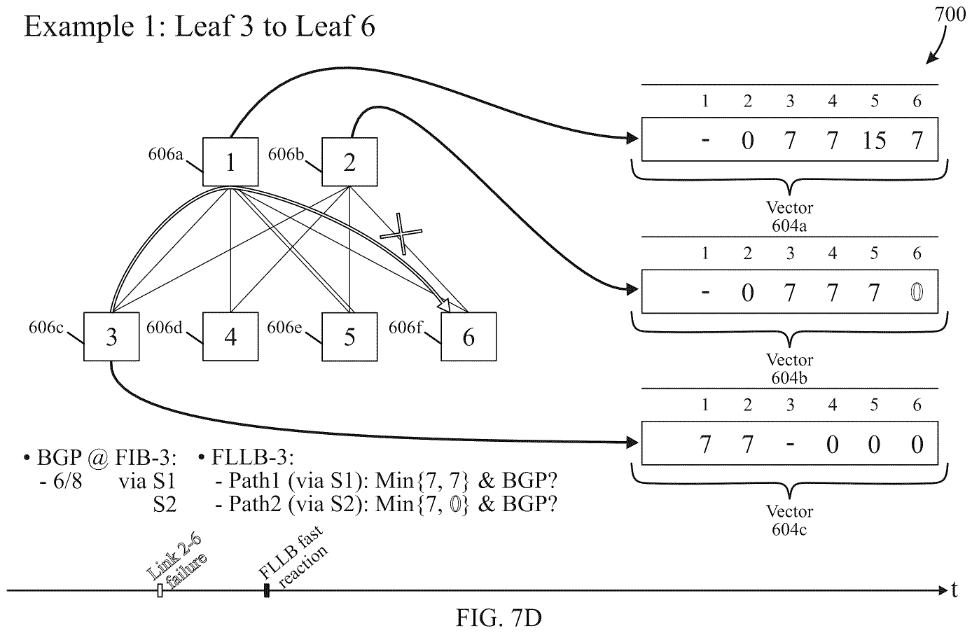

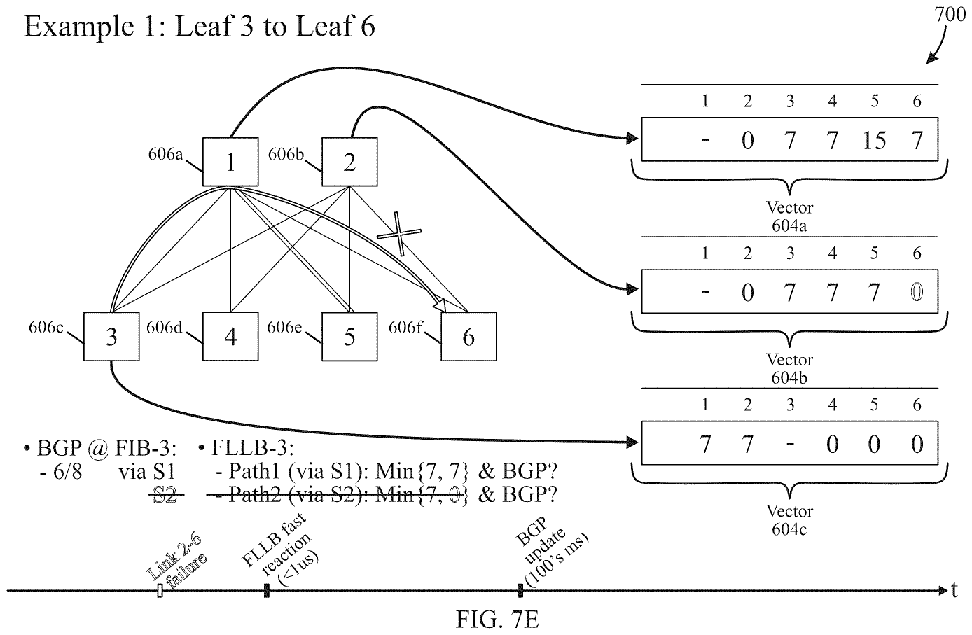

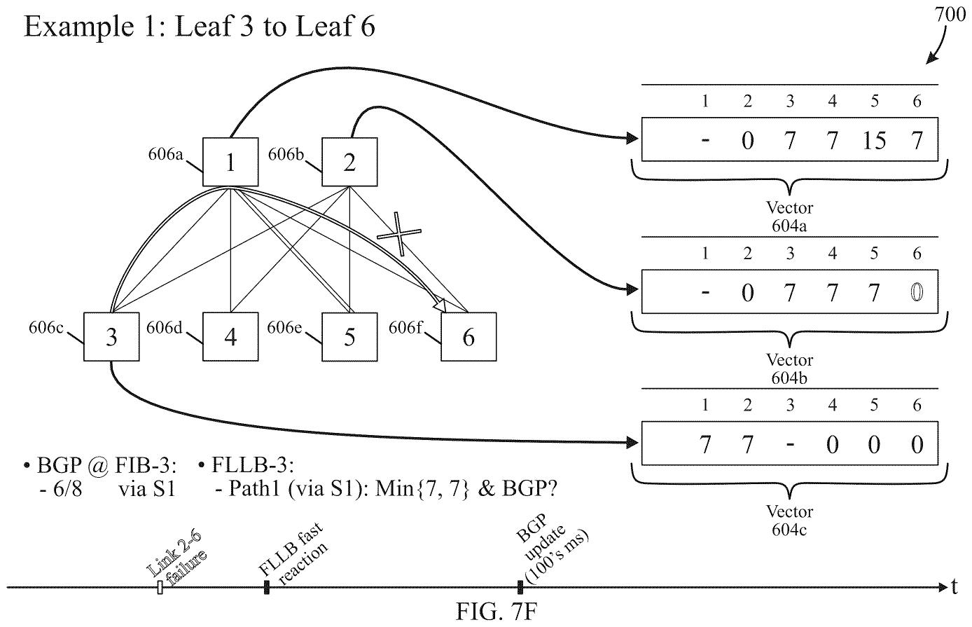

FIGS. 7A-7F illustrate a first example 700 of applying the techniques herein to a data center fabric. Continuing the example of FIGS. 6A-6B, consider again nodes 606a-606f with vector 604a being the local vector of node 606a, vector 604b being the local vector of node 606b, and vector 604c being the local vector of node 606c.

Here, the FIB of node 606c (the third node) may indicate that there are two forwarding paths available to node 606f: a first path that traverses node 606a and a second path that traverses node 606b. Accordingly, the FLLB of node 606c may perform load balancing of its traffic towards node 696f across both paths, with its connectivity to node 606a and node 606b offering the same capacity.

Now, in FIG. 7B, assume that there is a link failure between node 606b and node 606f. In such a case, as shown in FIG. 7C, node 606b may update its vector, vector 604b, to indicate this loss of connectivity by changing the gradient associated with 606f from ‘7’ (e.g., representing a 400 G capacity) to a gradient of ‘0’ (e.g., representing no capacity). In turn, as shown in FIG. 7D, the FLLB fast reaction mechanism in the fabric may update node 606c as to this change. As would be appreciated, this can be performed currently on the order of less than 1 μs. As shown in FIG. 7E, as result of the FLLB notification, node 606c may remote the second path to node 606f via node 606b as a load balancing option. Eventually, node 606c will also be notified via BGP of the failure and update its FIB as well. However, this is likely to be on the order of hundreds of milliseconds and much slower than the FLLB fast reaction mechanism. Thus, as shown in FIG. 7F, node 606c may only use its path to node 606f via node 606a.

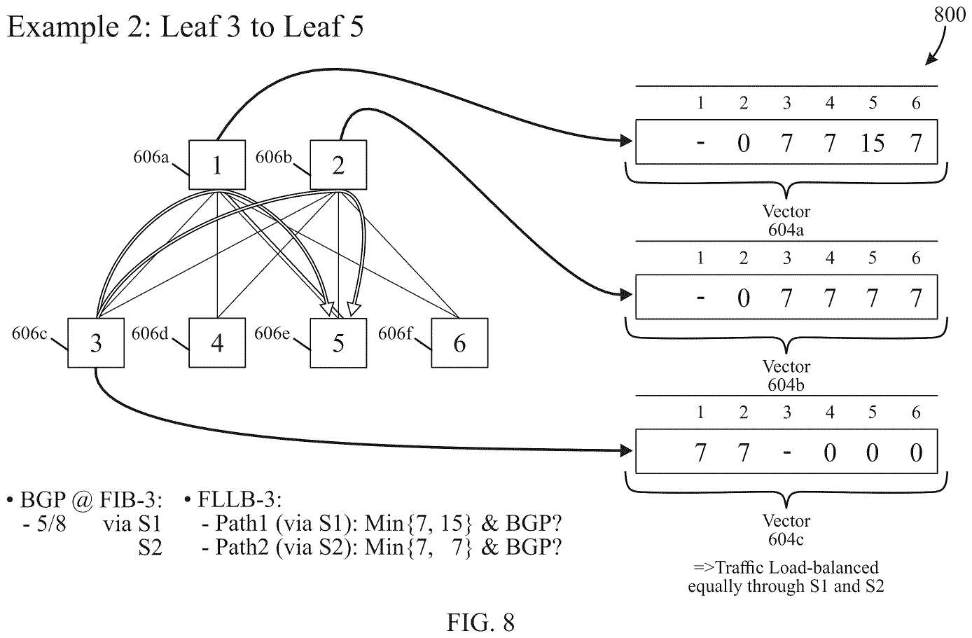

FIG. 8 illustrates a second example 800 of applying the techniques herein to a data center fabric. Continuing the prior examples, again consider a fabric that includes nodes 606a-606f. In the case of node 606c communicating with node 606e, its FIB may indicate that there are two paths available: one via node 606a and another via node 606b. Similarly, its FLLB information may indicate that both of these paths have similar capacities, as the connections to node 606a and to node 606b are both 400 G (e.g., as represented by a gradient value of ‘7’), thanks to its own vector, vector 604c.

While the connection between node 606a and node 606e has a capacity of 800 G (e.g., as represented by gradient value ‘15’) and the connection between node 606b and node 606e has only a capacity of 400 G, the overall capacities of both end-to-end paths is the minimum across all hops. Thus, the capacity of the path from node 606c to node 606e via node 606a is still 400 G, which is the capacity of the connection between node 606c and node 606a. Consequently, node 606c may load balance its traffic to node 606e equally between the two paths.

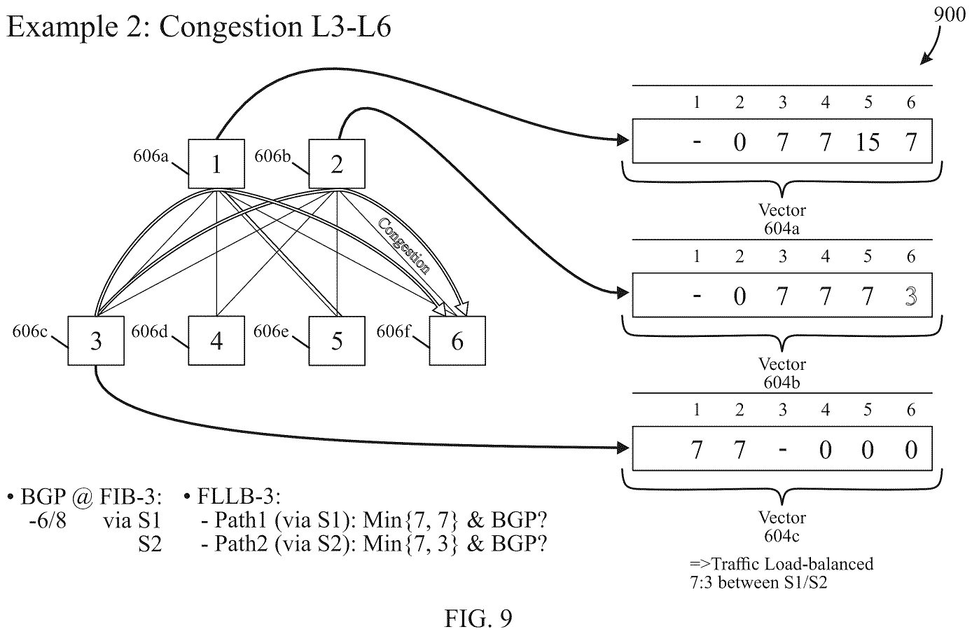

FIG. 9 illustrates a third example 900 of applying the techniques herein to a data center fabric. Continuing the prior examples with respect to node 606a through 606f, assume now that there is congestion between node 606b and node 606f. In such a case, node 606b may update its vector, vector 604b, to change the gradient for this connection from a gradient value of ‘7’ to a gradient value of ‘3.’ This change is then propagated via the FLLB mechanism to node 606c.

As a result of the decrease in capacity, node 606c may treat the path to node 606f via node 606b as having a reduced capacity by taking the minimum of the capacities of the connections between node 606c and node 606b (e.g., gradient value of ‘7’) and between node 606b and node 606f (e.g., the updated gradient value of ‘3’). Consequently, node 606c may load balance its traffic to node 606f using a 7:3 ratio between its two available paths, thereby favoring the path via node 606a.

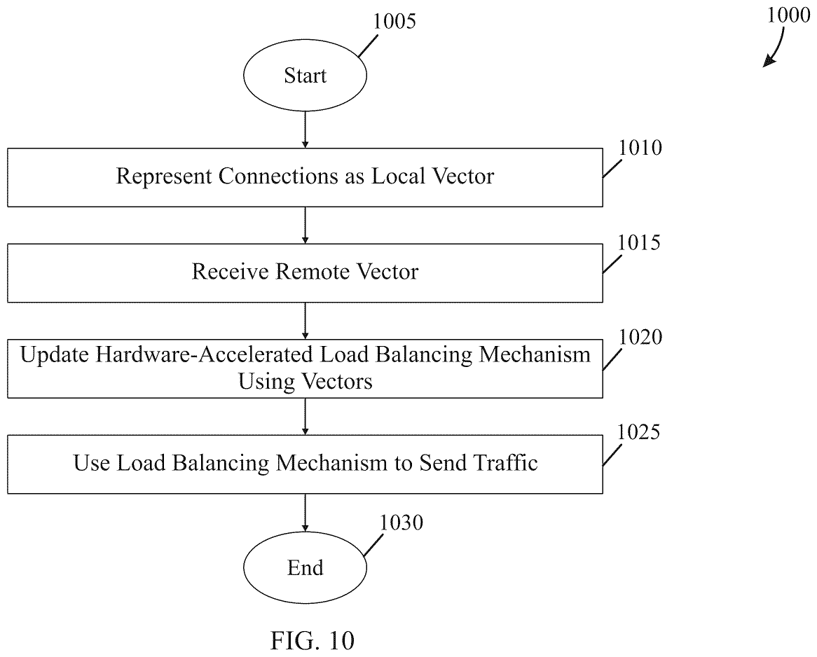

FIG. 10 illustrates an example simplified procedure for the hardware acceleration of routing protocols in data center fabrics, in accordance with one or more implementations described herein. For example, a non-generic, specifically configured device (e.g., device 200), may perform procedure 1000 (e.g., a method) by executing stored instructions (e.g., AI process 248 and/or segment routing process 249). The procedure 1000 may start at step 1005, and continues to step 1010, where, as described in greater detail above, the device (e.g., a controller, server, NIC, TOR, etc.) may represent one or more connections between the apparatus and one or more other devices in the network as a local vector having gradients that represent capacities of those one or more connections. In various implementations, each position in the local vector is associated with a different Border Gateway Protocol (BGP) identifier. In various deployments, the network is an artificial intelligence or high-performance computing fabric.

At step 1015, as detailed above, the device may receive a second vector from a remote device from among the one or more other devices that represents any available connections for the remote device and their capacities. In some implementations, the second vector indicates a failure in a particular connection between the remote device and a third device in the network. In some instances, the device may also receive a Border Gateway Protocol (BGP) notification of the failure after receiving the second vector. In further cases, the second vector indicates that a particular connection between the remote device and a third device in the network is experiencing congestion.

At step 1020, the device may update a hardware-accelerated load balancing mechanism using the local vector and the second vector, as described in greater detail above. In various implementations, the device executes the hardware-accelerated load balancing mechanism within an application specific integrated circuit (ASIC). In some instances, the hardware-accelerated load balancing mechanism uses weighted equal cost multipath (wECMP).

At step 1025, as detailed above, the device may use the hardware-accelerated load balancing mechanism to send a load-balanced portion of its traffic to the remote device based on the local vector and the second vector. In some instances, this may entail avoiding sending traffic via a path that includes the particular connection that failed between the remote device and the third device in the network. In other instances, this may entail reducing a percentage of traffic sent by the device via a path that comprise the particular connection experiencing congestion.

### Procedure 1000 May Then End at Step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for hardware acceleration of routing protocols in data center fabrics, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
representing, by a device in a network, one or more connections between the device and one or more other devices in the network as a local vector having gradients that represent capacities of those one or more connections;
receiving, at the device, a second vector from a remote device from among the one or more other devices that represents any available connections for the remote device and their capacities;
updating, by the device, a hardware-accelerated load balancing mechanism of the device using the local vector and the second vector; and
using, by the device, the hardware-accelerated load balancing mechanism of the device to send a load-balanced portion of its traffic to the remote device based on the local vector and the second vector.

2. The method as in claim 1, wherein the device executes the hardware-accelerated load balancing mechanism within an application specific integrated circuit (ASIC).

3. The method as in claim 1, wherein the hardware-accelerated load balancing mechanism uses weighted equal cost multipath (wECMP).

4. The method as in claim 1, wherein each position in the local vector is associated with a different Border Gateway Protocol (BGP) identifier.

5. The method as in claim 1, wherein the second vector indicates a failure in a particular connection between the remote device and a third device in the network.

6. The method as in claim 5, wherein using the hardware-accelerated load balancing mechanism of the device to send a load-balanced portion of its traffic to the remote device based on the local vector and the second vector comprises:
avoiding sending traffic via a path that includes the particular connection that failed between the remote device and the third device in the network.

7. The method as in claim 5, further comprising:
receiving a Border Gateway Protocol (BGP) notification of the failure after receiving the second vector.

8. The method as in claim 1, wherein the second vector indicates that a particular connection between the remote device and a third device in the network is experiencing congestion.

9. The method as in claim 8, wherein using the hardware-accelerated load balancing mechanism of the device to send a load-balanced portion of its traffic to the remote device based on the local vector and the second vector comprises:
reducing a percentage of traffic sent by the device via a path that comprise the particular connection experiencing congestion.

10. The method as in claim 1, wherein the network is an artificial intelligence or high-performance computing fabric.

11. An apparatus, comprising:
one or more network interfaces to communicate with a network;
a processor coupled to the one or more network interfaces and configured to execute one or more processes; and
a memory configured to store a process that is executable by the processor, the process when executed configured to:
represent one or more connections between the apparatus and one or more other devices in the network as a local vector having gradients that represent capacities of those one or more connections;
receive a second vector from a remote device from among the one or more other devices that represents any available connections for the remote device and their capacities;
update a hardware-accelerated load balancing mechanism using the local vector and the second vector; and
use the hardware-accelerated load balancing mechanism to send a load-balanced portion of its traffic to the remote device based on the local vector and the second vector.

12. The apparatus as in claim 11, wherein the apparatus executes the hardware-accelerated load balancing mechanism within an application specific integrated circuit (ASIC) of the one or more network interfaces.

13. The apparatus as in claim 11, wherein the hardware-accelerated load balancing mechanism uses weighted equal cost multipath (wECMP).

14. The apparatus as in claim 11, wherein each position in the local vector is associated with a different Border Gateway Protocol (BGP) identifier.

15. The apparatus as in claim 11, wherein the second vector indicates a failure in a particular connection between the remote device and a third device in the network.

16. The apparatus as in claim 15, wherein the apparatus uses the hardware-accelerated load balancing mechanism to send a load-balanced portion of its traffic to the remote device based on the local vector and the second vector by:
avoiding sending traffic via a path that includes the particular connection that failed between the remote device and the third device in the network.

17. The apparatus as in claim 15, wherein the process when executed is further configured to:
receive a Border Gateway Protocol (BGP) notification of the failure after receiving the second vector.

18. The apparatus as in claim 11, wherein the second vector indicates that a particular connection between the remote device and a third device in the network is experiencing congestion.

19. The apparatus as in claim 18, wherein the apparatus uses the hardware-accelerated load balancing mechanism to send a load-balanced portion of its traffic to the remote device based on the local vector and the second vector by:
reducing a percentage of traffic sent by the apparatus via a path that comprise the particular connection experiencing congestion.

20. A tangible, non-transitory, computer-readable medium storing program instructions that cause a device in a network to execute a process comprising:
representing, by the device, one or more connections between the device and one or more other devices in the network as a local vector having gradients that represent capacities of those one or more connections;
receiving, at the device, a second vector from a remote device from among the one or more other devices that represents any available connections for the remote device and their capacities;
updating, by the device, a hardware-accelerated load balancing mechanism of the device using the local vector and the second vector; and
using, by the device, the hardware-accelerated load balancing mechanism of the device to send a load-balanced portion of its traffic to the remote device based on the local vector and the second vector.
